(19) United States
(12) Patent Application Publication
(10) Pub. No.: US 2022/0416438 A1
(43) Pub. Date: Dec. 29, 2022

(54) ANTENNA ARRAY AND METHODS THEREOF

(71) Applicant: Intel Corporation, Santa Clara, CA (US)

(72) Inventor: Sreenivas KASTURI, Hillsboro, OR (US)

(21) Appl. No.: 17/356,546

(22) Filed: Jun. 24, 2021

(51) Int. Cl. H01Q 21/06; H01Q 19/00

(52) U.S. Cl. CPC H01Q 21/065; H01Q 19/005

(57) ABSTRACT

An antenna array includes: a plurality of patch antenna structures, wherein each patch antenna structure of the plurality of patch antenna structures includes: an active element configured to emit radiofrequency waves, a parasitic reflector element, and a parasitic director element, wherein the parasitic reflector element and the parasitic director element are configured to direct the radiofrequency waves emitted by the active element towards a corresponding emission direction; a first beamforming circuit configured to control the active elements of a first subset of patch antenna structures to provide beamforming in a first azimuth direction corresponding to the first subset of patch antenna structures, and a second beamforming circuit configured to control the active elements of a second subset of patch antenna structures to provide beamforming in a second azimuth direction corresponding to the second subset of patch antenna structures.

### TECHNICAL FIELD

This disclosure relates generally to antenna structures, antenna arrays, and methods thereof (e.g., a method of operating an antenna array).

### BACKGROUND

To enable the Enhanced Mobile Broadband (eMBB) promise of 5G and provide high data-rate throughputs, large bandwidth swaths have been released in the millimeter-Wave (mmW) spectrum worldwide. In view of the short range transmission nature at these frequencies, mmW radio transmitters are highly localized in the form of access points (APs) or small cell base stations (BSs). For indoor applications, the mmW spectrum suffers from high signal attenuation through walls and other obstacles. To take these constraints into account many mmW radio transmitter deployments are attached to the ceiling indoors, and are configured to provide hemispherical coverage (360° in azimuth/horizontal plane, and 180° in elevation/vertical plane).

### BRIEF DESCRIPTION OF THE DRAWINGS

Throughout the drawings, like reference numbers are used to depict the same or similar elements, features, and structures. The drawings are not necessarily to scale, emphasis instead generally being placed upon illustrating aspects of the disclosure. In the following description, some aspects of the disclosure are described with reference to the following drawings, in which:

FIG. 1 exemplarily shows an access point in a schematic view;

FIG. 2 exemplarily shows a patch antenna structure in a schematic view;

FIG. 3A exemplarily shows an antenna array in a schematic view;

FIG. 3B exemplarily shows a ceiling-mount in a schematic view;

FIG. 4A and FIG. 4B each exemplarily shows an access point in a schematic view;

FIG. 4C exemplarily shows a simulated beam pattern; and

FIG. 5 exemplarily shows a flow diagram of a method of operating an antenna array.

### DESCRIPTION

The following detailed description refers to the accompanying drawings that show, by way of illustration, specific details and aspects in which the disclosure may be practiced. One or more aspects are described in sufficient detail to enable those skilled in the art to practice the disclosure. Other aspects may be utilized and structural, logical, and electrical changes may be made without departing from the scope of the disclosure. The various aspects described herein are not necessarily mutually exclusive, as some aspects can be combined with one or more other aspects to form new aspects. Various aspects are described in connection with methods and various aspects are described in connection with devices (e.g., an antenna structure, an antenna array, a ceiling-mount, or an access point). However, it may be understood that aspects described in connection with methods may similarly apply to the devices, and vice versa. Throughout the drawings, it should be noted that like reference numbers are used to depict the same or similar elements, features, and structures.

The present disclosure is based on the realization that patch antenna structures including active and passive elements provide an energy-efficient and cost-effective solution to form antenna arrays to achieve hemispherical (or at least partially hemispherical) coverage. An array of patch antenna structures (e.g., configured as patch Yagi-Uda antennas, also referred to herein as Yagi-Uda patch antennas), each including at least one parasitic reflector and at least one parasitic director (e.g., one or more parasitic directors), may enable wide coverage and beam-steering capabilities (e.g., 360° coverage in at least one direction, for example in the azimuth direction), with a reduced number of actively driven radiating elements, thus reducing the power consumption and the overall costs of the setup. As an exemplary configuration, the present disclosure may be based on the realization that an array of patch Yagi-Uda antennas may provide indoor coverage (e.g., as part of a ceiling-mount, mounted or to be mounted at a ceiling, e.g. to provide an access point), e.g. for 5G applications, with reduced power consumption and reduced electrical/mechanical complexity.

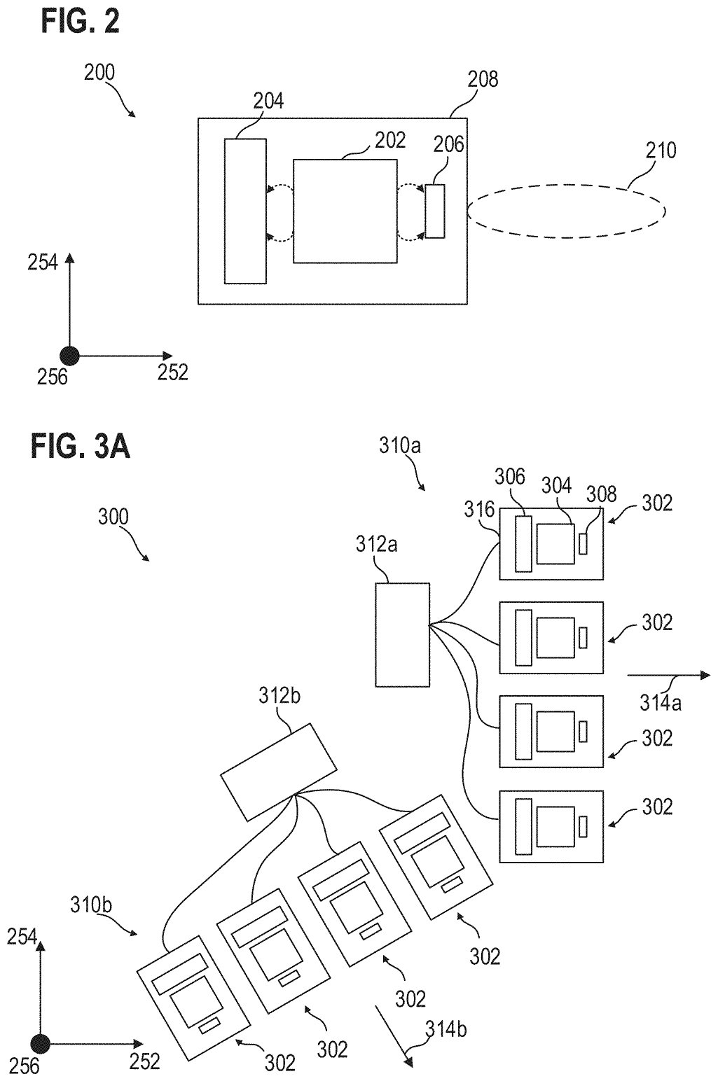

The term “patch antenna” or “patch antenna element” as used herein, may include an antenna (or antenna element) having a two-dimensional physical geometry, as known in the art. A patch antenna may have a low profile, illustratively a planar geometry, e.g. with rectangular, square, circular, elliptical, or triangular shape, as examples (it is however understood that the shape is not restricted to these examples, and any continuous shape may be provided). A patch antenna may include a patch of metal material disposed over a ground plane. The patch of metal material may be disposed on one side of a substrate (e.g., a dielectric substrate), and the ground plane may be disposed on the opposite side of the substrate with respect to the patch (see also FIG. 2). As an alternative configuration, the patch may be disposed above the ground plane with dielectric spacers therebetween. The patch may be configured (e.g., dimensioned) as a function of the wavelength of the radiofrequency (RF) waves that the patch antenna may transmit and/or receive, as described in further detail below. As an example, the patch may have a length in the range from one-quarter wavelength to a full wavelength, e.g. a length of a half-wavelength. A patch antenna may also be referred to as “microstrip antenna”. The term “patch antenna structure”, as used herein, may describe a structure including a patch-like active element (a patch antenna) and one or more additional elements (e.g., one or more parasitic elements, such as a reflector and one or more directors).

The terms “azimuth” and “elevation” as used herein, e.g. in relation to an angle, a plane, or a direction may describe the radiation properties of an antenna (e.g., an antenna structure, or an antenna array) as a function of space. The term “azimuth” may be related to the horizontal direction with respect to the radiating space (illustratively, the azimuth plane may be the horizontal plane, e.g. the x-y plane, around the antenna), and the term “elevation” may be related to the vertical direction with respect to the radiating space (illustratively, the elevation plane may be a vertical plane orthogonal to the horizontal plane, e.g. orthogonal to the x-y plane, e.g. may be the y-z plane around the antenna). Correspondingly, the azimuth angle may describe a direction towards which the antenna beam is directed with respect to the horizontal plane (illustratively, an angle between an axis of the antenna and the antenna beam in the horizontal direction), and the elevation angle may describe a direction towards which the antenna beam is directed with respect to the vertical plane (illustratively, an angle between an axis of the antenna and the antenna beam in the vertical direction).

The term “beamforming”, as used herein, may describe the spatial focusing of a radiation pattern of an antenna (e.g., of an antenna array) towards a specific direction (e.g., towards a receiving device), as known in the art. A plurality of antenna elements (e.g., a plurality of patch antenna structures) forming an antenna array may transmit a respective radiofrequency signal with a shift (e.g., a phase shift and/or an amplitude shift) with respect to the other antenna elements of the array. Based on the spacing among the antenna elements within the array, the shift(s) among the radiofrequency signals that the antenna elements transmit may provide a constructive and destructive interference of the (shifted) radiofrequency signals in such a way that the overall (in other words, total, or overlapping) radiofrequency signal is stronger in a desired direction and weaker in the other directions, thus “focusing” the radiofrequency signal (illustratively, providing a focused radiation pattern). Illustratively, controlling the radiofrequency signal from each antenna element in the array may provide controlling the shape and the direction of the resulting signal beam. The individual feed signals to the antenna elements may provide that the overall sum of the instantaneous amplitudes from the different antenna elements add or subtract in such a way that the desired beam is focused towards the desired direction. Beamforming may include “analog beamforming”, in which each antenna element of the array has a corresponding phase shifter to provide the phase shift for that antenna element. Additionally or alternatively, beamforming may include “digital beamforming”, in which each antenna element of the array has a corresponding transceiver and data converter. The digital beamforming may provide a simple handling of multiple beams simultaneously from one array.

The term “beam steering” (also referred to as “beamsteering” or “beam-steering”), as used herein, may describe the dynamic control of the signal phase of the input signal at the radiating elements (e.g., at the antenna elements) of an array, to vary the direction of the signal that the array transmits. Beam steering may be combined with beam forming, to vary the direction of a focused antenna beam (e.g., towards a specific target, for example towards a specific user).

An antenna array may include: a plurality of patch antenna structures. Each patch antenna structure of the plurality of patch antenna structures may include an active element configured to emit radiofrequency waves, a parasitic reflector element, and one or more parasitic director elements. The parasitic reflector element and the one or more parasitic director elements are configured to direct the radiofrequency waves, which the active element emits, towards a corresponding emission direction (illustratively, to direct the radiofrequency waves emitted by the active element towards a corresponding emission direction). The antenna array may further include a first beamforming circuit configured to control the active elements of a first subset of patch antenna structures of the plurality of patch antenna structures to provide beamforming in a first azimuth direction corresponding to the first subset of patch antenna structures, and a second beamforming circuit configured to control the active elements of a second subset of patch antenna structures of the plurality of patch antenna structures to provide beamforming in a second azimuth direction corresponding to the second subset of patch antenna structures.

An antenna array may include: a plurality of sets of patch antenna structures. Each set of patch antenna structures of the plurality of sets of patch antenna structures may include a respective plurality of patch antenna structures. Each patch antenna structure of the sets of patch antenna structures may include an active element configured to emit radiofrequency waves, a parasitic reflector element, and one or more parasitic director elements. The parasitic reflector element and the one or more parasitic director elements are configured to direct the radiofrequency waves, which the active element emits, towards a corresponding emission direction. The antenna array may further include a first beamforming circuit configured to control the active elements of a first set of patch antenna structures of the plurality of sets of patch antenna structures to provide beamforming in a first azimuth direction corresponding to the first set of patch antenna structures, and a second beamforming circuit configured to control the active elements of a second set of patch antenna structures of the plurality of sets of patch antenna structures to provide beamforming in a second azimuth direction corresponding to the second set of patch antenna structures. The sets of patch antenna structures may be disposed in sectors (e.g., at an angle in the range from 15° to 120° with respect to one another, for example in the range from 30° to 90° with respect to one another), or may be disposed in a circular arrangement (e.g., may form a continuous circular arrangement).

A ceiling-mount may include the antenna array, and a mounting structure configured to allow a mounting of the ceiling-mount at a ceiling.

A method of operating an antenna array may be provided. The antenna array includes a plurality of patch antenna structures. Each patch antenna structure of the plurality of patch antenna structures includes an active element configured to emit radiofrequency waves, a parasitic reflector element, and one or more parasitic director elements. The parasitic reflector element and the one or more parasitic director elements are configured to direct the radiofrequency waves, which the active element emits, towards a corresponding emission direction. The method includes: controlling the active elements of a first subset of patch antenna structures of the plurality of patch antenna structures to provide beamforming in a first azimuth direction corresponding to the first subset of patch antenna structures; and controlling the active elements of a second subset of patch antenna structures of the plurality of patch antenna structures to provide beamforming in a second azimuth direction corresponding to the second subset of patch antenna structures.

Various aspects are described herein in relation to applications for the 5G technology standard (Fifth Generation (5G) mobile networks), e.g. various aspects are described in relation to devices, patch antenna structures, antenna arrays, etc. that may be configured for 5G applications (e.g., a patch antenna structure or an antenna array may be configured to transmit/receive RF waves in the millimeter wavelength range). It is however understood that a configuration for 5G applications is only an example, and the strategy described herein may apply in a corresponding manner to devices, antenna elements, antenna arrays, etc. configured for other types of technologies or technology standards, e.g., WiFi, Bluetooth (BT), near-field communication (NFC), Global System for Mobile Communications (GSM), New Radio (NR), Universal Mobile Telecommunications Service (UMTS), Long Term Evolution (LTE), 2G, 2.5G, 3G, 3.5G, 4G, 6G, 7G, 8G, 3GPP, as other examples.

The term “antenna element”, as used herein, may include an element of an antenna, e.g. an element of an antenna array. An antenna element may be understood as an individual component capable of transmitting and/or receiving radiofrequency communication signals (a radiofrequency communication signal may also be referred to herein as radiofrequency signal), illustratively capable of transmitting and/or receiving radiofrequency waves. An antenna element may operate in combination with one or more other antenna elements, e.g. as part of an antenna array, to provide combined transmission/reception of radiofrequency communication signals, e.g. to provide beamforming capabilities for transmitting/receiving radiofrequency waves. In the context of the present description, a patch antenna structure may be an example of antenna element.

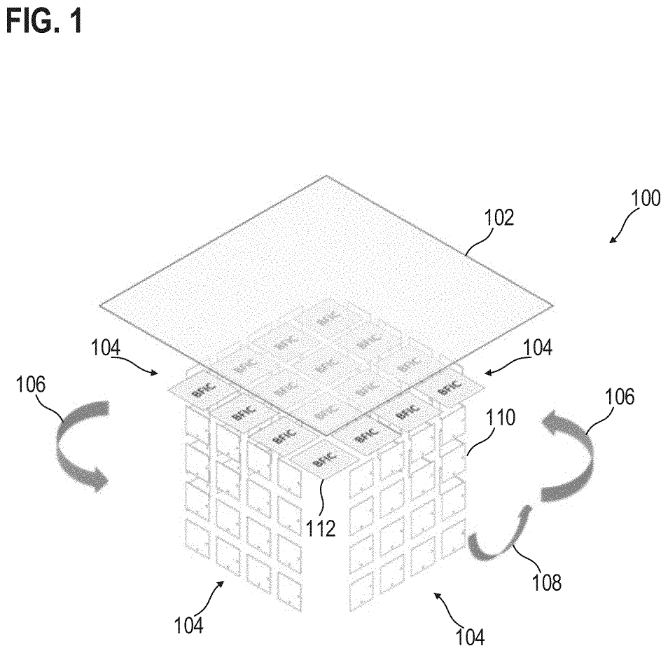

FIG. 1 exemplarily shows an access point 100 in a schematic perspective view. The access point 100 may be mounted at a ceiling 102, e.g. to provide indoor coverage, and may be configured according to a conventional approach. The access point 100 may be an exemplary configuration of a typical mmW ceiling-mount access point (AP) with a conventional arrangement of antenna array modules 104 (also referred to as antenna array panels).

The access point 100 includes a plurality of planar antenna array modules 104 (e.g., four in the configuration in FIG. 1, one module per 90° sector) arranged in 90° (90 degrees) sectors around to cover 360° (360 degrees) in the azimuth direction (as illustrated by the first arrows 106), and using limited beam-steering to cover 180° (180 degrees) in the elevation direction (as illustrated by the second arrow 108). The planar array modules 104 may be arranged perpendicular to the ceiling 102 to provide the desired coverage. Illustratively, a planar array module 104 in the configuration in FIG. 1 may be arranged such that the respective azimuth plane is perpendicular to the plane over which the array of antenna elements 110 extends.

The planar array modules 104 include a plurality of actively driven antenna elements 110 (e.g., a plurality of patch antennas), and a plurality of beamforming circuits 112 (e.g., a plurality of beamformer integrated circuits, BFICs). A typical beamforming circuit (e.g., a typical mmW beamformer integrated circuit) may support four antenna elements, so that the (e.g., mmW) array modules 104 may be configured as 4×4 antenna arrays, each including thus four beamforming circuits 112. Illustratively, in the configuration shown in FIG. 1, four beamforming circuits 112 (e.g., 4 mmW BFICs) may feed an antenna array module 104 configured as a 4×4 antenna array. The configuration may meet the gain and/or Effective Isotropic Radiated Power (EIRP) requirements per the link budget.

The plurality of planar array modules 104 (illustratively, the plurality of planar directional arrays) overcome the limited beam steering capabilities in azimuth of a planar directional array and provide hemispherical coverage. Each antenna array module 104 may provide full horizontal beam steering coverage within its 90° sector. Individually controlling the radiofrequency signals that the patch antennas 110 transmit may provide directing the overall beam of an antenna array module 104 in a desired direction in the horizontal plane. In addition, each antenna array module 104 may provide full vertical beam steering, and two antenna array modules 104 together may provide a full 180° coverage in the elevation direction. In an exemplary configuration, the antenna array modules 104 may be down-tilted by a few degrees, thus forming a “bowl-like” shape. The tilted configuration may provide avoiding a null (blind spot) right under the access point 100.

The present disclosure may be based on the realization that a conventional configuration for an access point, e.g. as shown in FIG. 1, may lead to an increased cost, and to significant power and thermal envelopes to contend with. This may be related to a typical patch antenna having a gain of about 5 dBi, and to a mmW access point usually requiring up to 17 dBi of gain per panel. To provide the required gain and the full beam steering capability, the beamforming circuits drive all the elements in each panel (e.g., 16 elements in the configuration in FIG. 1, and thus four antenna elements per beamforming circuit). To provide 360° coverage without significant coverage loss at least four complete antenna array modules each comprising 4×4 antenna arrays may be provided (for a total of 64 driven antenna elements), thus requiring a total of 16 mmW BFICs. The overall cost of the solution increases, the electrical design takes into account a higher power draw to support the beamforming circuits (e.g., the 16 BFICs), and the mechanical design accounts for mitigating a much higher thermal envelope. In addition, the profile of each vertical panel may lead to an undesirably large box-like enclosure for the access point, jutting from under the ceiling.

The present disclosure relates to the use of patch antenna structures including parasitic elements (e.g., a reflector, and one or more directors) in antenna array modules, to provide hemispherical or at least partially hemispherical coverage (e.g., in an access point, or in a base station) with a reduced power consumption, and thus with reduced thermal and mechanical envelope. In an exemplary configuration, the patch antenna structures may be configured as patch Yagi-Uda antennas. Illustratively, the parasitic elements, in combination with the arrangement of the patch antenna structure within the antenna array module(s) may provide achieving sufficient coverage without the need of actively driving large numbers of antenna elements, as described in further detail below.

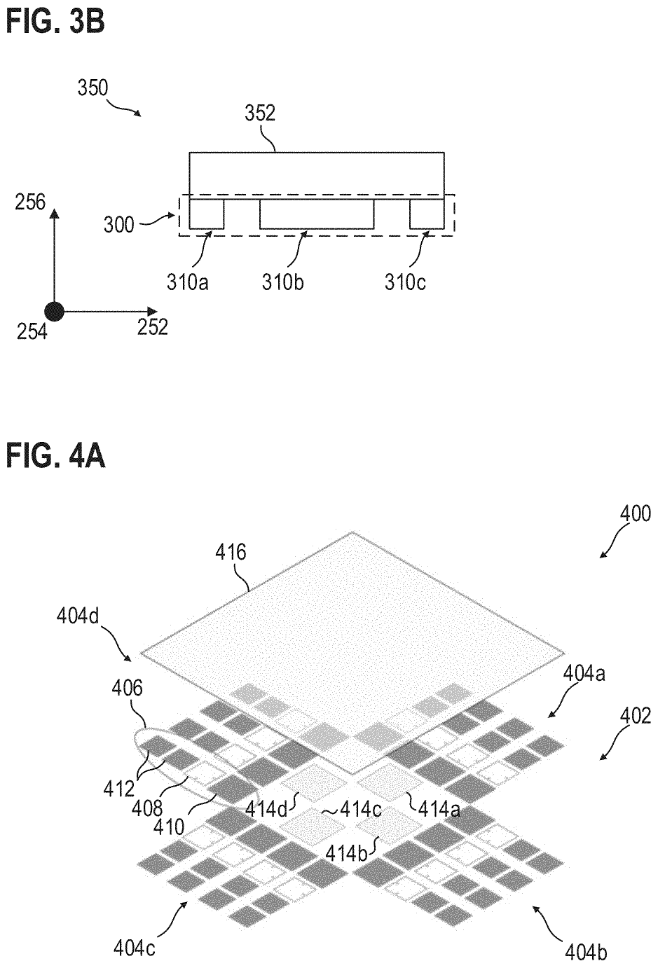

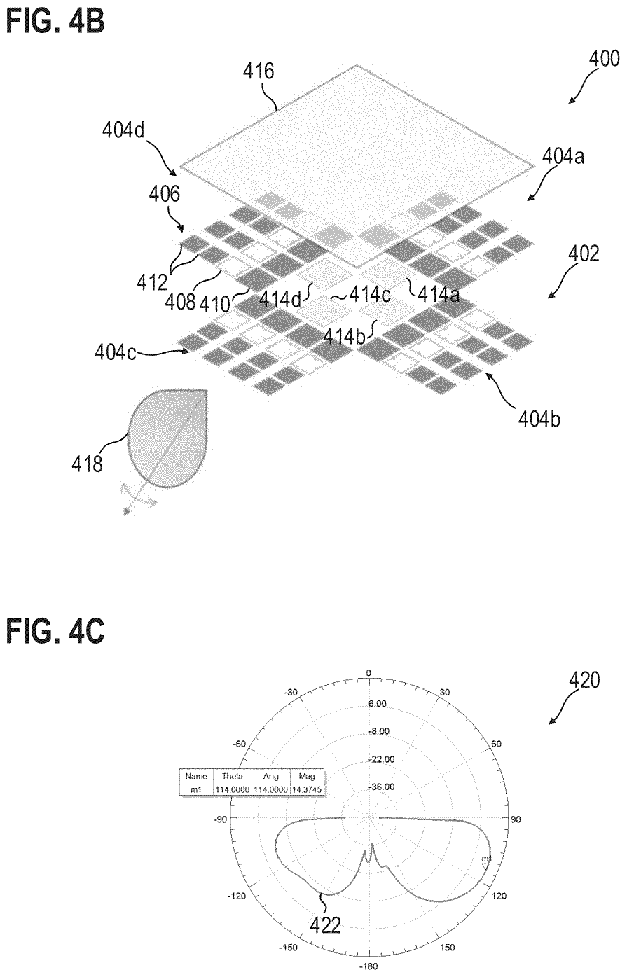

The patch antenna structures are provided in an arrangement (see for example FIG. 3A, FIG. 4A, and FIG. 4B) that enables at once: (1) to achieve wider bandwidth required for mmW, (2) to achieve sufficient gain without many actively driven elements, and (3) to accomplish hemispherical coverage in a low-profile form factor. As an exemplary configuration, the arrangement described herein may include Yagi-Uda antennas configured as microstrip patch elements, arranged in a 4×1×4 subarray configuration, backed with a ground plane to provide a high gain, hemispherical coverage.

FIG. 2 shows a patch antenna structure 200 in a schematic top view. The patch antenna structure 200 may have a substantially planar geometry, e.g. may extend substantially in the horizontal plane (e.g., the x-y plane, defined by the first direction 252, e.g. the x-direction, and the second direction 254, e.g. the y-direction, in FIG. 2). Illustratively, the extension of the patch antenna structure 200 in the horizontal plane may be greater (e.g., three times greater, five times greater, ten times greater, or more than ten times greater) than the extension in the vertical plane (e.g., in the y-z plane, defined by the second direction 254 and the third direction 256, e.g. the z-direction or vertical direction, in FIG. 2).

The patch antenna structure 200 may include an active element 202 (also referred to herein as a radiating element) configured to emit a radiofrequency signal (illustratively, configured to emit radiofrequency waves). The active element 202 may be or may include a patch including a conducting material (e.g., a metal material, such as copper, aluminum, brass, as examples). The active element 202 may be configured to receive a feed signal (also referred to herein as driving signal, e.g. a voltage) and may be configured to emit the radiofrequency signal in response to the received feed signal. It is understood that the considerations described herein in relation to the emission (and transmission) of a radiofrequency signal (e.g., the emission/transmission of radiofrequency waves) at the patch antenna structure 200 (e.g., at the active element 202) may correspondingly apply to the reception of a radiofrequency signal at the patch antenna structure 200.

The patch antenna structure 200 (e.g., the active element 202) may be configured (e.g., dimensioned) as a function of the wavelength range (or frequency range) in which the patch antenna structure 200 should operate, e.g. as a function of the wavelength (or frequency) that the patch antenna structure 200 should transmit or receive. As an exemplary configuration, the patch antenna structure 200 may be configured for 5G applications, e.g. may be configured to operate at a frequency in the range from 24.25 GHz to 52.6 GHz (illustratively, may be configured to transmit/receive radiofrequency waves having a frequency in the range from 24.25 GHz to 52.6 GHz). Additionally or alternatively, the patch antenna structure 200 may be configured to operate at a frequency in the range from 450 MHz to 6 GHz. Considering the wavelength, the patch antenna structure 200 (e.g., the active element 202) may be configured to transmit (and/or to receive) radiofrequency waves having a wavelength in the range from 1 mm to 100 mm, for example in the range from 1 mm to 10 mm. It is however understood that these wavelength and frequency ranges are exemplary, and the patch antenna structure 200 may be configured (e.g., dimensioned) to transmit and/or receive radiofrequency waves having wavelength and frequency in different ranges (e.g., according to other types of technologies).

The active element 202 may be dimensioned as a function of the wavelength (and/or of the frequency) of the radiofrequency waves that the patch antenna structure 202 should transmit/receive according to equations known in the art, illustratively as a function of the wavelength of the radiofrequency waves that the active element 202 may emit/receive. As a numerical example, the active element 202 may have a length (illustratively, a lateral dimension along the second direction 254) of about one half of a wavelength within the dielectric medium (e.g., within the substrate 208, described below). As described above, a thickness of the active element 202 (illustratively, a lateral dimension along the vertical direction 256) may be much smaller than the length (and than the width) of the active element 202. As a numerical example, the thickness of the active element 202 may be about one-fortieth of a wavelength, or one-twentieth of a wavelength.

The patch antenna structure 202 may further include parasitic elements to control (e.g., to shape) a radiation pattern 210 corresponding to the patch antenna structure 202, e.g. to control a direction towards which the radiation pattern 210 points (a direction towards which the patch antenna structure 202 may transmit). As an exemplary configuration, the patch antenna structure 200 may be configured as a patch Yagi-Uda antenna.

The patch antenna structure 202 may include a parasitic reflector element 204 (also referred to as parasitic reflector, or reflector element) and one or more parasitic director elements 206 (also referred to as parasitic directors, or director elements). The parasitic reflector element 204 and the one or more parasitic director elements 206 may be configured to direct the radiofrequency waves, which the active element 202 emits, towards a corresponding emission direction (e.g., pointing towards the first direction 252 in the configuration in FIG. 2). Illustratively, the active element 202 may emit radiofrequency waves in two directions (at the two edges along the first direction 252), illustratively in a forward and backward direction (with respect to the direction into which the patch antenna structure 200 radiates), and the parasitic reflector element 204 may be configured (e.g., disposed) to reflect towards the forward direction the radiofrequency waves that the active element 202 emits in the backward direction. The parasitic reflector element 204 may have a length (e.g., a lateral dimension in the second direction 254) greater than the length of the active element 202, to provide that the parasitic reflector element 204 may collect and reflect towards the forward direction the radiofrequency waves in the backward direction.

The one or more parasitic director elements 206 may be configured to direct the radiofrequency waves (those that the active element 202 emits and those that the parasitic reflector element 204 reflects towards the forward direction) towards a desired emission direction (also referred to herein as transmission direction). Illustratively, the one or more parasitic director elements 206 may be configured to shape the radiation pattern 210 of the patch antenna structure 200 to point towards a desired emission direction.

The term “parasitic” may describe that the parasitic reflector element 204 and the one or more parasitic director elements 206 do not receive a corresponding feed signal (a corresponding input signal) during the operation of the patch antenna structure 200. Illustratively, the active element 202 may receive a feed signal to control the emission of the radiofrequency waves, and the radiofrequency waves that the active element 202 emits may parasitically excite the reflector element 204 and the one or more director elements 206.

The parasitic reflector element 204 and the one or more parasitic director elements 206 may have a “patch-like” configuration as the active element 202, illustratively a substantially planar geometry (a low-profile). The parasitic reflector element 204 and the one or more parasitic director elements 206 may include a conducting material (e.g., a metal material, such as copper, aluminum, brass, as examples).

The number of parasitic director elements 206 of the patch antenna structure 202 may be adapted in accordance with a desired control of the radiation pattern 210 (e.g., in accordance with a desired narrowing of the radiation pattern 210). Illustratively, in FIG. 2 a configuration with a parasitic director element 206 is shown, however the patch antenna structure 202 (e.g., the one or more parasitic director element 206) may include a plurality of parasitic director elements 206 (e.g., two, three, five, or more than five, as numerical examples), depending on a desired shaping of the radiation pattern 210. The plurality of parasitic director elements 206 may be disposed (e.g., in a line) along the direction of emission of the radiofrequency waves, e.g. along the forward direction in the configuration in FIG. 2.

The patch antenna structure 202 may further include a substrate 208 (e.g., a dielectric substrate, illustratively a substrate including an electrically insulating material, such as a glass-based or ceramic-based material). The various elements of the patch antenna structure 202 (e.g., the active element 202, the parasitic reflector element 204, the parasitic director element(s) 206) may be disposed on the substrate 208 (e.g., directly on, in direct physical contact with the substrate 208).

The patch antenna structure 202 may further include a ground plane (not shown in FIG. 2). The ground plane may be disposed on the substrate 208, at the opposite side (illustratively, on an opposite surface) of the substrate 208 with respect to the active element 202. By way of illustration, the ground plane may be disposed on (e.g., directly on) the surface of the substrate 208 opposite to the surface visible from the point of view of FIG. 2. The various elements of the patch antenna structure 200 (e.g., the active element 202, the parasitic reflector element 204, the parasitic director element(s) 206) may be disposed over the ground plane (illustratively, indirectly over, or indirectly on, with the substrate 208 therebetween). The ground plane may be or may include a sheet of conducting material (e.g., a sheet of metal material, such as copper). The ground plane may be configured to reflect the radiofrequency waves that the active element 202 emits and that propagate within the substrate 208 (illustratively, that propagate towards the ground plane).

In another exemplary configuration, instead of the substrate 208 the elements of the patch antenna structure 200 (e.g., the active element 202, the parasitic reflector element 204, the parasitic director element(s) 206) may be disposed on the ground plane with one or more dielectric spacers therebetween.

The patch antenna structure 200 may be configured such that the azimuth plane of the radiation pattern 210 is parallel to the substrate 208. Illustratively, the configuration (e.g., the disposition) of the elements (the active element 202, the reflector element 204, the director element(s) 206) of the patch antenna structure 200 provides that the radiation pattern 210 extends in a direction parallel to the substrate 208 (e.g., a direction parallel to the first direction 252). The azimuth plane for the patch antenna structure 200 may be the plane defined by the first direction 252 and the second direction 254 in FIG. 2 (illustratively, the azimuth plane may be parallel to the plane defined by the first direction 252 and the second direction 254).

The patch antenna structure 200 may be configured such that the radiation pattern 210 points away from the substrate 208 in the vertical direction (the third direction 256 in FIG. 2). The patch antenna structure 200 may be configured such that a main lobe of the radiation pattern 210 is at an elevation angle greater than 0° and less than 90° with respect to the substrate 208, for example at an elevation angle in the range from 15° to 60° with respect to the substrate 208. Illustratively, the configuration of the elements of the patch antenna structure 200 provides that the radiation pattern 210 points (away) in a direction at an angle with respect to the substrate 208.

The patch antenna structure 200 may be configured such that the radiation pattern 210 radiates along a forward direction (parallel to the substrate 208, illustratively the first direction 252 in FIG. 2) and points away from the substrate 208 along the vertical direction (the third direction 256).

The present disclosure may relate to the use of patch antenna structures configured as described in FIG. 2 to provide an antenna array with increased gain and reduced number of driven elements (see FIG. 3A). The proposed arrangement addresses the issues described in relation to the conventional configuration shown in FIG. 1 by leveraging a rethinking of an antenna configuration including parasitic elements (e.g., the Yagi-Uda antenna) and combining it with a microstrip patch form factor in a unique arrangement.

The configuration described herein (see FIG. 3A) may provide achieving gain and beam steering with fewer driven elements with respect to a conventional configuration. Each patch antenna structure (e.g., each Yagi-Uda patch antenna) includes only one driven patch with the other patches (reflector and director(s)) excited parasitically. The parasitic patches are designed and located to optimize the antenna beam in one direction (“forward”), thus leading to an increase in the gain with fewer elements. The configuration described herein (see FIG. 3A) may also provide achieving low profile and large bandwidth. A typical Yagi-Uda antenna may be designed with wire elements, such as dipoles, which are intrinsically narrow band. 5G mmW deployments may rely on large fractional bandwidths to take full advantage of the available spectrum and deliver maximum data rate. The use of microstrip patch antenna structures instead of dipole elements, and employing wideband design techniques, may enable meeting the 5G bandwidth requirements. In addition, the low-profile nature of microstrip patch antenna structures provides that the overall mechanical envelope of an access point (e.g., a mmW AP) may be significantly reduced, making a ceiling-mount an effectively unobtrusive installation.

FIG. 3A exemplarily shows an antenna array 300 in a schematic top view. The antenna array 300 may include a plurality of patch antenna structures 302. The patch antenna structures 302 may be configured as the patch antenna structure 200 described in relation to FIG. 2 (illustratively, the patch antenna structures 302 may include a respective active element 304, parasitic reflector element 306, and parasitic director element(s) 308). The active element 304, the parasitic reflector element 306, and the parasitic director element(s) 308 may be configured, respectively, as the active element 202, the parasitic reflector element 204, and the parasitic director element(s) 206 described in relation to FIG. 2. As an exemplary configuration, at least one (or more than one, or each) patch antenna structure 302 may be configured as a patch Yagi-Uda antenna. For clarity of representation only the active element 304, the parasitic reflector element 306, and the parasitic director element(s) 308 of one of the patch antenna structures 302 are labelled in FIG. 3A. It is understood that the representation in FIG. 3A may be simplified for purpose of explanation, and the antenna array 300 may include additional components with respect to those shown (e.g., a processor, a memory, a transceiver, etc.).

The patch antenna structures 302 of the antenna array 300 may be arranged (e.g., spatially and/or logically) in sets (also referred to herein as subsets) of patch antenna structures 302. In the exemplary configuration in FIG. 3A the antenna array 300 may include a first (sub)set 310a of patch antenna structures 302 and a second (sub)set 310b of patch antenna structures 302. It is however understood that the antenna array 300 may include any suitable number of (sub)set of patch antenna structures 302, e.g. three, four, five, or more than five (sub)sets, e.g. the antenna array 300 may include a third (sub)set, a fourth (sub)set, etc. By way of illustration, the antenna array 300 may be understood as including a plurality of sub-arrays, or (sub-)modules. The (sub) sets (e.g., the first (sub)set 310a, the second (sub)set 310b, the third (sub)set, etc.) may be one-dimensional (sub-)arrays of patch antenna structures 302.

As described in relation to FIG. 2, the elements of a patch antenna structure 302 may be disposed on a substrate 316 (and on a ground plane, not shown). The substrate 316 (and the ground plane) may be a respective substrate of each patch antenna structure 302, or may be a substrate common to the patch antenna structures 302 of a (sub)set, or may be a substrate common to all the patch antenna structures 302 of the antenna array 300.

Each (sub)set of patch antenna structures 302 may include a respective plurality of patch antenna structures 302. As a numerical example, a (sub)set of patch antenna structures 302 (e.g., the first (sub)set 310a and/or the second (sub)set 310b) may include a number of patch antenna structures 302 in the range from 2 to 10, for example in the range from 4 to 8, for example a (sub)set of patch antenna structures 302 may include 4 patch antenna structures 302. As another numerical example, a (total) number of patch antenna structures 302 of the antenna array 300 may be in the range from 4 to 64, for example in the range from 16 to 32. The number of patch antenna structures 302 may be adapted in accordance with a desired coverage that the antenna array 300 should provide (e.g., in accordance with desired emission/reception directions). As an exemplary configuration, the antenna array 300 may include four (sub)sets each including four patch antenna structures 302, e.g. the antenna array 300 may have a 4×1×4 configuration (with the (sub)sets disposed at 90° with respect to one another).

The antenna array 300 may further include a plurality of beamforming circuits 312a, 312b (e.g., a plurality of mmW beamformer integrated circuits). Each beamforming circuit 312a, 312b may be corresponding to a respective set 310a, 310b of patch antenna structures 302. In the exemplary configuration in FIG. 3A, the antenna array 300 may include a first beamforming circuit 312a corresponding to the first (sub)set 310a of patch antenna structures 302 (e.g., the first beamforming circuit 312a may be coupled with the patch antenna structures 302 of the first (sub)set 310a), and a second beamforming circuit 312b corresponding to the second (sub)set 310b of patch antenna structures 302 (e.g., the second beamforming circuit 312b may be coupled with the patch antenna structures 302 of the second (sub)set 310b). It is understood that the number of beamforming circuits may be in accordance with the number of sets of patch antenna structures, e.g. the antenna array 300 may include a third beamforming circuit corresponding to a third (sub)set of patch antenna structures, a fourth beamforming circuit corresponding to a fourth (sub)set, etc. A beamforming circuit may be or may include a processor configured to implement beamforming (and/or beam steering) by controlling the respective patch antenna structures.

A beamforming circuit may be configured to control (e.g., to feed) the active elements of the respective (sub)set of patch antenna structures 302 to provide beamforming (and/or beam steering) in an emission direction corresponding to that (sub)set. In the exemplary configuration in FIG. 3A, the first beamforming circuit 312a may be configured to control the active elements 304 of the first (sub)set 310a of patch antenna structures 302 to provide beamforming in a first azimuth direction 314a corresponding to the first (sub)set 310a of patch antenna structures 302, and the second beamforming circuit 312b may be configured to control the active elements 304 of the second (sub)set 310b of patch antenna structures 302 to provide beamforming in a second azimuth direction 314b corresponding to the second (sub)set 310b of patch antenna structures 302. It is understood that the configuration may apply also to further beamforming circuits of the antenna array 300, e.g., a third beamforming circuit may be configured to control the respective active elements of a third (sub)set of patch antenna structures 302 to provide beamforming in a third azimuth direction corresponding to the third subset of patch antenna structures 302, etc.

Illustratively, a beamforming circuit may be configured to control the respective emission of radiofrequency waves of the active elements 304 of the patch antenna structures 302 of the respective (sub)set to provide beamforming in the emission direction corresponding to that (sub)set. The beamforming circuit may be configured to implement beamforming in an analog manner (e.g., by controlling a phase shift of a respective phase shifter of each patch antenna structure 302, not shown) and/or in a digital manner (e.g., by adapting the respective feed signals that the beamforming circuit provides at the patch antenna structures 302).

The (sub)sets of patch antenna structures 302 may be arranged according to a desired coverage that the antenna array 300 should provide. As an exemplary configuration, adjacent (sub)sets of patch antenna structures 302 (e.g., the first subset 310a and the second subset 310b) may be disposed at an angle with one another in the range from 15° to 120°, for example in the range from 30° to 90°, for example at an angle with respect to one another of 45° or 90° (e.g., the (sub)sets may be disposed in 90° sectors). As another exemplary configuration, the (sub)sets of patch antenna structures 302 may form a substantially circular (and continuous) arrangement, e.g. the patch antenna structures 302 of the antenna array 300 may be disposed substantially along a circumference (with no sub-division in sectors). This configuration may provide a continuous (non-sectorized) coverage (e.g., 360° coverage). In the arrangement along a circumference there may be no spatial separation (in sectors) between different (sub)sets of patch antenna structures 302, which may form a continuous arrangement. In this configuration the (sub)sets may be understood to be “logically separated”, as different (sub)sets may be coupled to different beamforming circuits.

Illustratively, adjacent (sub)sets of patch antenna structures 302 (e.g., the first subset 310a and the second subset 310b) may be configured such that the respective azimuth directions (e.g., the first azimuth direction 314a and the second azimuth direction 314b) may be at an angle with one another in the range from 15° to 120°, for example in the range from 30° to 90°, for example at an angle with respect to one another of 45° or 90°. As another example, the (sub)sets of patch antenna structures 302 may be configured such that the respective azimuth directions are uniformly (and continuously) distributed around a circumference.

The configuration of the antenna array 300, with respect to a conventional approach, provides a coverage in desired directions with a reduced number of actively driven antenna elements. Illustratively, the planar configuration of the antenna array 300 and the use of patch antenna structures with parasitic elements ensure that coverage (and beam steering) may be provided in desired azimuth directions (e.g., to cover 360°) with reduced power consumption, and with a less complex thermal envelope. As an exemplary configuration, considering a 1×4 array (e.g., of patch Yagi-Uda antennas) per 90° sector to provide beam steering capability in the azimuth, a single beamforming circuit (e.g., a single BFIC) may supply (in other words, feed) a respective sector.

As an exemplary additional (and optional) component, the antenna array 300 may include at least one (low-profile) dielectric resonator antenna coupled with a patch antenna structure 302 of the plurality of patch antenna structures 302. For example, the antenna array 300 may include a plurality of dielectric resonator antennas each coupled with a respective patch antenna structure 302 of a (sub)set. As another example, the antenna array 300 may include a plurality of dielectric resonator antennas each coupled with a respective patch antenna structure 302 of the array 300. The dielectric resonator antenna(s) may enhance the transmission of radiofrequency waves at the patch antenna structure(s).

The approach described herein is not limited to the frequency ranges described above (illustratively is not limited to an operation at mmW), e.g. is not limited to 5G applications, but may be extensible to other frequency ranges as well, assuming feasible antenna array sizes.

The approach described herein is not limited to patch antenna structures, which however provide a greater efficiency, and enable beamforming and beam steering capabilities in a simple manner. Another option may be to use horn antenna elements or dipole Yagi-Uda antennas, which however provide a less efficient and less adaptable operation.

The antenna array 300 described herein may be for use in an access point, or in a base station, as exemplary applications. Illustratively, as an example, an access point (e.g., a mmW access point) may include the antenna array 300. As another example, a base station may include the antenna array 300. The approach described herein may provide lower costs and a simpler low-profile construction of AP/small-cell indoor base station deployments, e.g. in the 5G infrastructure space. This may provide a cost-efficient solution to provide continuous coverage in a typical multi-level office building, in which multiple access points/base stations may be present. It is however understood that the applications of the antenna array 300 are not limited to access points/base stations, and the antenna array 300 may be for use in a variety of devices in which the low-profile and the reduced power consumption may provide an improved operation.

FIG. 3B exemplarily shows a ceiling-mount 350 in a schematic side view. The ceiling-mount 350 may be configured for mounting at a ceiling, illustratively may be configured to allow mounting the array 300 at a ceiling. The ceiling-mount 350 may include the antenna array 300 (e.g., including the first (sub)set 310a, the second (sub)set 310b, and a third (sub)set 310c), and a mounting structure 352 configured to allow a mounting of the ceiling-mount 350 at a ceiling. It is understood that a ceiling-mount is an example of a possible device to allow a mounting of the array 300 at a desired location, and the considerations described herein may apply in a corresponding manner to other types of devices (e.g., to mount the array 300 at a floor, or at a side wall, as other examples). It is also understood that the configuration of the antenna array in FIG. 3B (e.g., with the (sub)sets 310a, 310b, 310c in 90° sectors) is exemplary, and other configurations may be provided (e.g., with different sectors, or with a circular arrangement).

The mounting structure 352 may be or may include any suitable component to enable mounting of the ceiling-mount 350 at a ceiling. As examples, the mounting structure 352 may include a support structure and one or more mounting elements, such as one or more screws, one or more bolts, one or more adhesive elements, or the like. It is understood that the relative arrangement of the mounting structure 352 with respect to the antenna array 300 shown in FIG. 3B is exemplary, and other relative arrangements may be provided (e.g., the mounting structure may be arranged at a side with respect to the antenna array 300).

The ceiling-mount 350 (e.g., the mounting structure 352) may be configured such that, in the case that the ceiling-mount 350 is mounted at a ceiling, the substrate of the antenna array 300 (e.g., a common substrate, or the individual substrates of the patch antenna structures 302) is parallel to the ceiling. Illustratively, the ceiling-mount 350 may be configured to allow placing the antenna array 300 parallel to the ceiling (e.g., so that the active elements 304 of the patch antenna structures 302 are disposed, and extend, parallel to the ceiling). This disposition may provide the (e.g., 360°) coverage in the azimuth, as described in further detail below.

The ceiling-mount 350 (e.g., the mounting structure 352) may be configured such that, in the case that the ceiling-mount 350 is mounted at a ceiling, the azimuth plane of a radiation pattern of at least one patch antenna structure (e.g., of a radiation pattern of a (sub)set 310a, 310b, 310c, e.g. of a radiation pattern of each patch antenna structure) may be parallel to the ceiling. Illustratively, the azimuth plane of the radiation pattern may be parallel to the plane in which the patch antenna structures 302 extend (e.g., parallel to the substrate(s) of the antenna array 300). Additionally, the ceiling-mount 350 (e.g., the mounting structure 352) may be configured such that, in the case that the ceiling-mount 350 is mounted at a ceiling, a main lobe of the radiation pattern of at least one patch antenna structure (e.g., of a radiation pattern of a (sub)set 310a, 310b, 310c, e.g. of a radiation pattern of each patch antenna structure) is at an elevation angle greater than 0° and less than 90° with respect to the ceiling, for example at an elevation angle in the range from 15° to 60° with respect to the ceiling. Illustratively, the ceiling-mount 350 may allow mounting the antenna array 300 with respect to a ceiling in such a way that the antenna array 300 may radiate pointing slightly downwards with respect to the ceiling (in elevation). The configuration of the ceiling-mount in combination with the configuration of the patch antenna structures (with the parasitic elements) may provide the desired radiation pattern(s), e.g. around to provide coverage in azimuth and slightly tilted downwards in elevation.

FIG. 4A and FIG. 4B each exemplarily shows an access point 400 in a schematic perspective view. The access point 400 may include an antenna array 402. The antenna array 402 may be configured according to the approach described herein, e.g. the antenna array 402 may be configured as the antenna array 300 described in relation to FIG. 3A (illustratively, the antenna array 402 may be an exemplary realization of the antenna array 300 described in relation to FIG. 3A). As an example, the access point 400 may be a ceiling-mount mmW access point, configured according to the approach described herein.

The antenna array 402 may include a plurality of sub-arrays, illustratively a plurality of (sub)sets of patch antenna structures, e.g. four (sub)sets 404a, 404b, 404c, 404d in the configuration in FIG. 4A and FIG. 4B. Each (sub)set 404a, 404b, 404c, 404d may include a respective plurality of patch antenna structures 406 (e.g., a respective plurality of patch Yagi-Uda antennas), each including a respective active element 408, parasitic reflector element 410, and one or more parasitic director elements 412 (e.g., two parasitic director elements 412 in the configuration in FIG. 4A and FIG. 4B). The antenna array 402 may include a plurality of beamforming circuits, e.g. four beamforming circuits 414a, 414b, 414c, 414d in the configuration in FIG. 4A and FIG. 4B, each associated with (e.g., coupled to) a corresponding (sub)set of patch antenna structures 406.

The access point 400 (illustratively, the antenna array 402) may be mounted at a ceiling 416 (e.g., via a ceiling-mount, not shown), for example to provide coverage inside a building. In the exemplary configuration in FIG. 4A and FIG. 4B, the patch antenna structures 406 (e.g., the patch Yagi-Uda antennas) are elements of 1×4 (sub-)arrays 404a, 404b, 404c, 404d, and the four 1×4(sub-)arrays are arranged in four directions to provide 360° coverage in azimuth. With the configuration proposed herein, the total number of driven elements for 360° coverage is only 16, compared to 64 (for a four panel 4×4 arrangement as described in relation to FIG. 1). This also reduces the total number of beamforming circuits 414a, 414b, 414c, 414c (e.g., the total number of mmW BFICs), e.g. to four, significantly bringing down the power, cost and thermal requirements.

FIG. 4B shows a depiction of the beam direction for the proposed configuration, e.g. with exemplary reference to the radiation pattern 418 of one of the (sub)sets 404c. As shown, the 1×4 array 404a, 404b, 404c, 404d in each 90° sector provides beam steering capability in the azimuth. In view of the antenna array 402 being a planar array in a horizontal plane parallel to the ceiling 416 (illustratively, there is no array in the vertical dimension), there is no beam steering in the elevation direction. However, the higher gain with larger beam coverage may still provide hemispherical coverage, thus obviating this potential issue.

FIG. 4C exemplarily shows a graph 420 (a polar radiation plot) representing a simulated beam pattern 422. The simulated beam pattern 422 (obtained using full-wave electromagnetic analysis) may represent the actual beam pattern in the elevation plane for a patch Yagi-Uda antenna operating at 28 GHz. The simulated beam pattern 422 shows the high gain and coverage of the beam that an antenna array configured according to the approach described herein may provide.

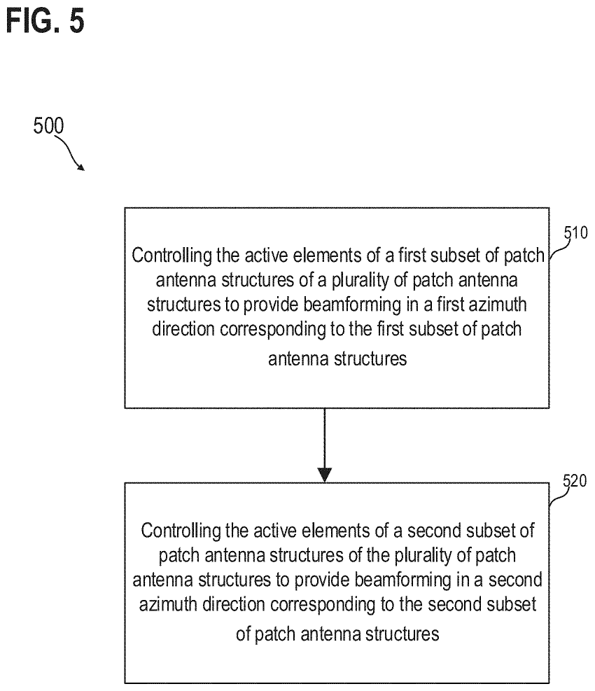

FIG. 5 exemplarily shows a flow diagram of a method 500 of operating an antenna array (e.g., of operating the antenna array 300, 402 described in relation to FIG. 3A to FIG. 4C).

The method 500 may include, in 510, controlling the active elements of a first subset of patch antenna structures of a plurality of patch antenna structures (e.g., a plurality of patch Yagi-Uda antennas) to provide beamforming in a first azimuth direction corresponding to the first subset of patch antenna structures.

The method 500 may include, in 520, controlling the active elements of a second subset of patch antenna structures of the plurality of patch antenna structures to provide beamforming in a second azimuth direction corresponding to the second subset of patch antenna structures.

Controlling the active elements may include providing a corresponding feed signal to the active elements, e.g. to drive an emission of radiofrequency waves in accordance with the desired beamforming. As an example, controlling the active elements may include controlling a respective phase shifter corresponding to an active element (e.g., coupled with the active element) to provide a respective phase shift for a radiofrequency signal that the active element emits.

In the following, various examples are provided that may include one or more aspects described above with reference to an antenna array (e.g., the antenna array 300, 402), a ceiling-mount (e.g., the ceiling-mount 350), and a method (e.g., the method 500). It may be intended that aspects described in relation to the antenna array or the ceiling-mount may apply also to the method, and vice versa.

Example 1 is an antenna array including: a plurality of patch antenna structures, wherein each patch antenna structure of the plurality of patch antenna structures includes: an active element configured to emit radiofrequency waves, a parasitic reflector element, and one or more parasitic director elements, wherein the parasitic reflector element and the one or more parasitic director elements are configured to direct the radiofrequency waves, which the active element emits, towards a corresponding emission direction; a first beamforming circuit configured to control the active elements of a first subset of patch antenna structures of the plurality of patch antenna structures to provide beamforming in a first azimuth direction corresponding to the first subset of patch antenna structures, and a second beamforming circuit configured to control the active elements of a second subset of patch antenna structures of the plurality of patch antenna structures to provide beamforming in a second azimuth direction corresponding to the second subset of patch antenna structures.

In example 2, the antenna array according to example 1 may optionally further include a third beamforming circuit configured to control the respective active elements of a third subset of patch antenna structures of the plurality of patch antenna structures to provide beamforming in a third azimuth direction corresponding to the third subset of patch antenna structures.

In example 3, the antenna array according to example 1 or 2 may optionally further include that the first subset of patch antenna structures and the second subset of patch antenna structures are configured such that the first azimuth direction and the second azimuth direction are at an angle with respect to one another in the range from 15° to 120°, for example in the range from 30° to 90°. As an example, the first azimuth direction and the second azimuth direction may be at an angle with respect to one another of 45° or 90°.

In example 4, the antenna array according to example 1 or 2 may optionally further include that the patch antenna structures of the first subset of patch antenna structures and the patch antenna structures of the second subset of patch antenna structures are arranged around a circumference. Illustratively, the patch antenna structures may form a continuous circular arrangement (a continuous circular array) of patch antenna structures.

In example 5, the antenna array according to any one of examples 1 to 4 may optionally further include a substrate. The plurality of patch antenna structures may be disposed on the substrate (e.g., directly on the substrate). At least one (e.g., each) patch antenna structure of the plurality of patch antenna structures may be configured such that a azimuth plane of a radiation pattern of the at least one patch antenna structure is parallel to the substrate.

In example 6, the antenna array according to example 5 may optionally further include that at least one (e.g., each) patch antenna structure of the plurality of patch antenna structures is configured such that a main lobe of the radiation pattern of the at least one patch antenna structure is at an elevation angle greater than 0° and less than 90° with respect to the substrate, for example at an elevation angle in the range from 15° to 60° with respect to the substrate.

In example 7, the antenna array according to any one of examples 1 to 6 may optionally further include that at least one (e.g., each) patch antenna structure of the plurality of patch antenna structures is configured to operate at a frequency in the range from 450 MHz to 6 GHz and/or from 24.25 GHz to 52.6 GHz.

In example 8, the antenna array according to any one of examples 1 to 7 may optionally further include that the active element of at least one (e.g., each) patch antenna structure of the plurality of patch antenna structures is configured to emit radiofrequency waves having a wavelength in the range from 1 mm to 100 mm, for example in the range from 1 mm to 10 mm.

In example 9, the antenna array according to any one of examples 1 to 8 may optionally further include that the first subset of patch antenna structures includes a number of patch antenna structures in the range from 2 to 10, for example in the range from 4 to 8, for example the first subset of patch antenna structures includes 4 patch antenna structures, and/or that the second subset of patch antenna structures includes a number of patch antenna structures in the range from 2 to 10, for example in the range from 4 to 8, for example the second subset of patch antenna structures includes 4 patch antenna structures.

In example 10, the antenna array according to any one of examples 1 to 9 may optionally further include that at least one (e.g., each) patch antenna structure of the plurality of patch antenna structures further includes a ground plane, and that the active element, the reflector element, and the director element of the at least one patch antenna structure are disposed over the ground plane. Illustratively, the ground plane may be disposed at the opposite side of a dielectric substrate (or of dielectric spacers) with respect to the active element, the reflector element, and the director element(s).

In example 11, the antenna array according to any one of examples 1 to 10 may optionally further include that the one or more parasitic director elements of at least one patch antenna structure of the plurality of patch antenna structures includes a plurality of parasitic director elements (e.g., two or three parasitic director elements).

In example 12, the antenna array according to any one of examples 1 to 11 may optionally further include that at least one (e.g., more than one, or each) patch antenna structure of the plurality of patch antenna structures is configured as a patch Yagi-Uda antenna.

In example 13, the antenna array according to any one of examples 1 to 12 may optionally further include that the plurality of patch antenna structures include a number of patch antenna structures in the range from 4 to 64, for example in the range from 16 to 32.

In example 14, the antenna array according to any one of examples 1 to 13 may optionally further include a dielectric resonator antenna coupled with at least one patch antenna structure of the plurality of patch antenna structures.

Example 15 is an access point including an antenna array according to any one of examples 1 to 14.

Example 16 is a base station including an antenna array according to any one of examples 1 to 14.

Example 17 is a ceiling-mount including: an antenna array according to any one of examples 1 to 14, and a mounting structure configured to allow a mounting of the ceiling-mount at a ceiling.

As another example, a system may include the antenna array according to any one of examples 1 to 14, and a mounting structure configured to allow a mounting of the antenna array at a ceiling.

In example 18, the ceiling-mount according to example 17 may optionally further include that the ceiling-mount is configured such that, in the case that the ceiling-mount is mounted at the ceiling, the substrate of the antenna array is parallel to the ceiling.

In example 19, the ceiling-mount according to example 17 or 18 may optionally further include that the ceiling-mount is configured such that, in the case that the ceiling-mount is mounted at the ceiling, a azimuth plane of a radiation pattern of at least one (e.g., each) patch antenna structure of the plurality of patch antenna structures is parallel to the ceiling.

In example 20, the ceiling-mount according to any one of examples 17 to 19 may optionally further include that the ceiling-mount is configured such that, in the case that the ceiling-mount is mounted at the ceiling, a main lobe of the radiation pattern of at least one (e.g., of each) patch antenna structure of the plurality of patch antenna structures is at an elevation angle greater than 0° and less than 90° with respect to the ceiling (illustratively, pointing downwards from the ceiling), for example at an elevation angle in the range from 15° to 60° with respect to the ceiling.

Example 21 is a method of operating an antenna array, the antenna array including a plurality of patch antenna structures. Each patch antenna structure of the plurality of patch antenna structures includes: an active element configured to emit radiofrequency waves, a parasitic reflector element, and a parasitic director element. The parasitic reflector element and the parasitic director element are configured to direct the radiofrequency waves, which the active element emits, towards a corresponding emission direction. The method includes: controlling the active elements of a first subset of patch antenna structures of the plurality of patch antenna structures to provide beamforming in a first azimuth direction corresponding to the first subset of patch antenna structures; and controlling the active elements of a second subset of patch antenna structures of the plurality of patch antenna structures to provide beamforming in a second azimuth direction corresponding to the second subset of patch antenna structures.

In example 22, the method according to example 21 may include one, or more than one, or all the features of any one of the examples 1 to 20, adapted accordingly.

Example 23 is an apparatus including means to carry out the method of example 21 or 22.

Example 24 is an antenna array including: a plurality of patch antenna structures. Each patch antenna structure of the plurality of patch antenna structures includes: an active element configured to emit radiofrequency waves, a parasitic reflector element, and one or more parasitic director elements. The parasitic reflector element and the one or more parasitic director elements are configured to direct the radiofrequency waves, which the active element emits, towards a corresponding emission direction. The antenna array further includes a plurality of beamforming circuits configured to control the active elements of the plurality of patch antenna structures to provide beamforming in a plurality of azimuth directions.

In example 25, the antenna array according to example 24 may optionally further include that the patch antenna structures of the plurality of patch antenna structures are disposed in sectors, each sector corresponding to a respective (sub)set of patch antenna structures. As an example, the plurality of patch antenna structures may be disposed in 15° sectors, or 30° sectors, or 90° sectors.

In example 26, the antenna array according to example 24 may optionally further include that the patch antenna structures of the plurality of patch antenna structures are disposed around a circumference. As an example, the plurality of patch antenna structures may be disposed around the complete circumference, e.g. to fully cover 360°.

In example 27, the antenna array according to any one of examples 24 to 26 may optionally further include that the plurality of azimuth directions are parallel to a plane over which the patch antenna structures of the plurality of patch antenna structures are disposed (and extend).

Example 28 is one or more non-transient computer readable media, configured to cause one or more processors, when executed, to perform a method of operating an antenna array. The antenna array may include a plurality of patch antenna structures. Each patch antenna structure of the plurality of patch antenna structures includes: an active element configured to emit radiofrequency waves, a parasitic reflector element, and a parasitic director element. The parasitic reflector element and the parasitic director element are configured to direct the radiofrequency waves, which the active element emits, towards a corresponding emission direction. The method stored in the non-transient computer readable media includes controlling the active elements of a first subset of patch antenna structures of a plurality of patch antenna structures to provide beamforming in a first azimuth direction corresponding to the first subset of patch antenna structures; and controlling the active elements of a second subset of patch antenna structures of the plurality of patch antenna structures to provide beamforming in a second azimuth direction corresponding to the second subset of patch antenna structures.

The word “exemplary” is used herein to mean “serving as an example, instance, or illustration.” Any example or design described herein as “exemplary” is not necessarily to be construed as preferred or advantageous over other examples or designs.

The words “plurality” and “multiple” in the description or the claims expressly refer to a quantity greater than one. The terms “group (of)”, “set [of]”, “collection (of)”, “series (of)”, “sequence (of)”, “grouping (of)”, etc., and the like in the description or in the claims refer to a quantity equal to or greater than one, i.e. one or more. Any term expressed in plural form that does not expressly state “plurality” or “multiple” likewise refers to a quantity equal to or greater than one.

The terms “processor” or “controller” as, for example, used herein may be understood as any kind of technological entity that allows handling of data. The data may be handled according to one or more specific functions that the processor or controller execute. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The term “software” refers to any type of executable instruction, including firmware.

This disclosure may utilize or be related to wireless communication technologies. While some examples may refer to specific wireless communication technologies, the examples provided herein may be similarly applied to various other wireless communication technologies, both existing and not yet formulated, particularly in cases where such wireless communication technologies share similar features as disclosed regarding the following examples.

The term “connected” can be understood in the sense of a (e.g. mechanical and/or electrical), e.g. direct or indirect, connection and/or interaction. For example, several elements can be connected together mechanically such that they are physically retained (e.g., a plug connected to a socket) and electrically such that they have an electrically conductive path (e.g., signal paths exist along a communicative chain).

The term “metal material” may be used herein to describe a metal (e.g., a pure or substantially pure metal), a mixture of more than one metal, a metal alloy, an intermetallic material, a conductive metal compound (e.g., a nitride), and the like. Illustratively, the term “metal material” may be used herein to describe a material having an electrical conductivity typical of a metal, for example an electrical conductivity greater than 10⁶ S/m at a temperature of 20° C.

While the above descriptions and connected figures may depict electronic device components as separate elements, skilled persons will appreciate the various possibilities to combine or integrate discrete elements into a single element. Such may include combining two or more circuits from a single circuit, mounting two or more circuits onto a common chip or chassis to form an integrated element, executing discrete software components on a common processor core, etc. Conversely, skilled persons will recognize the possibility to separate a single element into two or more discrete elements, such as splitting a single circuit into two or more separate circuits, separating a chip or chassis into discrete elements originally provided thereon, separating a software component into two or more sections and executing each on a separate processor core, etc. Also, it is appreciated that particular implementations of hardware and/or software components are merely illustrative, and other combinations of hardware and/or software that perform the methods described herein are within the scope of the disclosure.

It is appreciated that implementations of methods detailed herein are exemplary in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method.

All acronyms defined in the above description additionally hold in all claims included herein.

While the disclosure has been particularly shown and described with reference to specific embodiments, it should be understood by those skilled in the art that various changes in form and detail may be made therein without departing from the spirit and scope of the disclosure as defined by the appended claims. The scope of the disclosure is thus indicated by the appended claims and all changes which come within the meaning and range of equivalency of the claims are therefore intended to be embraced.

What is claimed is:

1. An antenna array comprising:
a plurality of patch antenna structures,
wherein each patch antenna structure of the plurality of patch antenna structures comprises: an active element configured to emit radiofrequency waves, a parasitic reflector element, and a parasitic director element, wherein the parasitic reflector element and the parasitic director element are configured to direct the radiofrequency waves emitted by the active element towards a corresponding emission direction;
a first beamforming circuit configured to control the active elements of a first subset of patch antenna structures of the plurality of patch antenna structures to provide beamforming in a first azimuth direction corresponding to the first subset of patch antenna structures, and
a second beamforming circuit configured to control the active elements of a second subset of patch antenna structures of the plurality of patch antenna structures to provide beamforming in a second azimuth direction corresponding to the second subset of patch antenna structures.

2. The antenna array according to claim 1, further comprising:
a third beamforming circuit configured to control the respective active elements of a third subset of patch antenna structures of the plurality of patch antenna structures to provide beamforming in a third azimuth direction corresponding to the third subset of patch antenna structures.

3. The antenna array according to claim 1,
wherein the first subset of patch antenna structures and the second subset of patch antenna structures are configured such that the first azimuth direction and the second azimuth direction are at an angle with respect to one another in the range from 30° to 90°.

4. The antenna array according to claim 1,
wherein the patch antenna structures of the first subset of patch antenna structures and the patch antenna structures of the second subset of patch antenna structures are arranged around a circumference.

5. The antenna array according to claim 1, further comprising:
a substrate,
wherein the plurality of patch antenna structures are disposed on the substrate, and
wherein at least one patch antenna structure of the plurality of patch antenna structures is configured such that a azimuth plane of a radiation pattern of the at least one patch antenna structure is parallel to the substrate.

6. The antenna array according to claim 5,
wherein at least one patch antenna structure of the plurality of patch antenna structures is configured such that a main lobe of the radiation pattern of the at least one patch antenna structure is at an elevation angle greater than 0° and less than 90° with respect to the substrate.

7. The antenna array according to claim 1,
wherein at least one patch antenna structure of the plurality of patch antenna structures is configured to operate at a frequency in the range from 24.25 GHz to 52.6 GHz.

8. The antenna array according to claim 1,
wherein the active element of at least one patch antenna structure of the plurality of patch antenna structures is configured to emit radiofrequency waves having a wavelength in the range from 1 mm to 100 mm.

9. The antenna array according to claim 1,
wherein the first subset of patch antenna structures comprises a number of patch antenna structures in the range from 4 to 8, and/or
wherein the second subset of patch antenna structures comprises a number of patch antenna structures in the range from 4 to 8.

10. The antenna array according to claim 1,
wherein at least one patch antenna structure of the plurality of patch antenna structures further comprises a ground plane, and
wherein the active element, the reflector element, and the director element of the at least one patch antenna structure are disposed over the ground plane.

11. The antenna array according to claim 1,
wherein the parasitic director element of at least one patch antenna structure of the plurality of patch antenna structures comprises a plurality of parasitic director elements.

12. The antenna array according to claim 1,
wherein at least one patch antenna structure of the plurality of patch antenna structures is configured as a patch Yagi-Uda antenna.

13. The antenna array according to claim 1,
wherein the plurality of patch antenna structures comprise a number of patch antenna structures in the range from 16 to 32.

14. The antenna array according to claim 1, further comprising:
a dielectric resonator antenna coupled with at least one patch antenna structure of the plurality of patch antenna structures.

15. An access point comprising an antenna array according to claim 1.

16. A ceiling-mount comprising:
an antenna array according to claim 1, and
a mounting structure configured to allow a mounting of the ceiling-mount at a ceiling.

17. The ceiling-mount according to claim 16,
wherein the ceiling mount is configured such that, in the case that the ceiling-mount is mounted at the ceiling, the substrate of the antenna array is parallel to the ceiling.

18. The ceiling-mount according to claim 16,
wherein the ceiling mount is configured such that, in the case that the ceiling-mount is mounted at the ceiling, a azimuth plane of a radiation pattern of at least one patch antenna structure of the plurality of patch antenna structures is parallel to the ceiling.

19. A method of operating an antenna array,
the antenna array comprising:
a plurality of patch antenna structures, wherein each patch antenna structure of the plurality of patch antenna structures comprises:
an active element configured to emit radiofrequency waves,
a parasitic reflector element, and
a parasitic director element,
wherein the parasitic reflector element and the parasitic director element are configured to direct the radiofrequency waves emitted by the active element towards a corresponding emission direction;
the method comprising:
controlling the active elements of a first subset of patch antenna structures of a plurality of patch antenna structures to provide beamforming in a first azimuth direction corresponding to the first subset of patch antenna structures; and
controlling the active elements of a second subset of patch antenna structures of the plurality of patch antenna structures to provide beamforming in a second azimuth direction corresponding to the second subset of patch antenna structures.

20. The method according to claim 19,
wherein at least one patch antenna structure of the plurality of patch antenna structures is configured as a patch Yagi-Uda antenna.
